(19) United States
(12) Patent Application Publication
(10) Pub. No.: US 2009/0117221 A1
(43) Pub. Date: May 7, 2009

(54) INJECTION MOLDING DEVICE

(75) Inventors: MING-CHIANG TSAI, Tu-Cheng (TW); YANG-CHANG CHIEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/189,637

(22) Filed: Aug. 11, 2008

(30) Foreign Application Priority Data
Nov. 6, 2007 (CN) 200710202405.3

(51) Int. Cl. B29C 45/40

(52) U.S. Cl. 425/556

(57) ABSTRACT

An injection molding device includes a male mold portion and a female mold portion mating with the male mold portion. The male mold portion includes a first molding surface defined therein. The female mold portion includes a through hole, an ejector sleeve received in the through hole and having a cavity hole, and a cavity insert received in the cavity hole of the ejector sleeve and having a second molding surface facing upwardly the first molding surface. An axis of the cavity hole is spaced from that of the through hole. If an eccentricity is presented on the molded lens, the cavity insert can be rotated to adjust the relative location of the first and second molding surface such that the eccentricity of the molded lens can be adjusted.

### BACKGROUND

1. Technical Field

The present invention relates to an injection molding device, particularly, to an injection molding device for molding a lens.

2. Description of Related Art

A typical injection mold includes two parts: a female mold portion and a male mold portion. The male mold portion and the female mold portion are usually aligned by locating pins. However, after repeated use of the molds, the locating pins become worn down and the male and female portions may no longer be aligned, resulting in inferior molded products.

Therefore, a new injection molding device is desired to overcome the above-described deficiency.

### SUMMARY

An injection molding device includes a male mold portion and a female mold portion mating with the male mold portion. The male mold portion includes a first molding surface defined therein. The female mold portion includes a base defining a through hole, an ejector sleeve received in the through hole and having a cavity hole defined therein, and a cavity insert received in the cavity hole of the ejector sleeve and having a second molding surface facing upwardly towards the first molding surface. An axis of the cavity hole is spaced from that of the through hole of the female mold portion.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof with reference to the accompanying drawings, in which:

FIG. 1 is an exploded, isometric view of an embodiment of an injection molding device, the injection molding including a male mold portion and a female mold portion;

FIG. 2 is a cross-sectional view of the female mold portion of the injection molding device, taken along II-II line of FIG. 1; and

FIG. 3 is a cross-sectional view of an ejector sleeve of the female mold portion, taken along III-III line of FIG. 1.

### DETAILED DESCRIPTION OF THE EMBODIMENTS

A detailed explanation of an injection molding device will now be made with reference to the drawings.

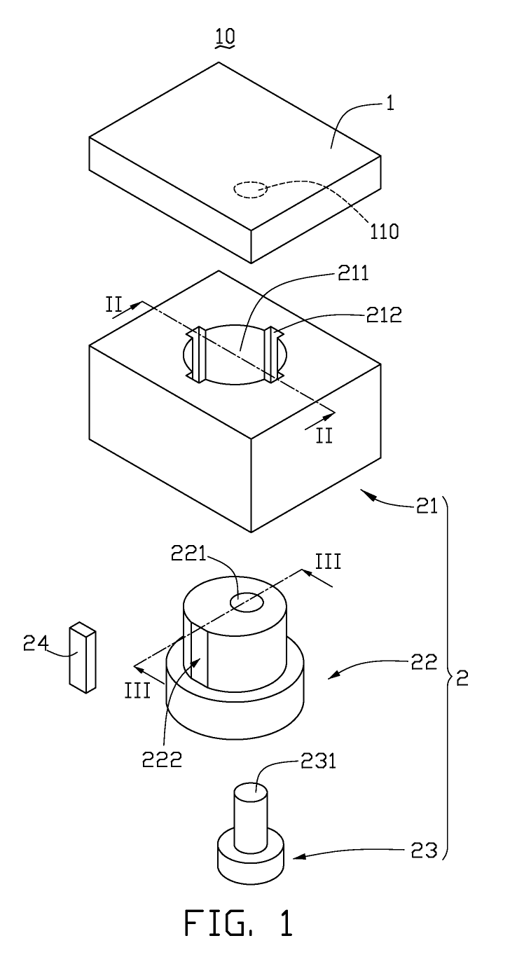

Referring to FIG. 1, one embodiment of an injection molding device 10 is shown. The injection molding device 10 includes a male mold portion 1 and a female mold portion 2. In one embodiment, the male mold portion 1 and the female mold portion 2 may be made of metal. The male mold portion 1 may be connected to an injection molding machine (not shown).

In the illustrated embodiment, the material to be molded is plastic. In other embodiment, the material to be molded may be glass or other moldable materials.

The male mold portion 1 includes a first molding surface 110. In one embodiment, the first molding surface 110 is configured for molding a subject which has a sphere surface or an aspheric surface. In the illustrated embodiment, the first molding surface 110 has a sphere-shaped configuration.

The female mold portion 2 includes a base 21, an ejector sleeve 22 rotatably received in the base 21, a cavity insert 23, and a retainer 24. The cavity insert 23 is inserted into the ejector sleeve 22. The retainer 24 is inserted between the base 21 and the ejector sleeve 22.

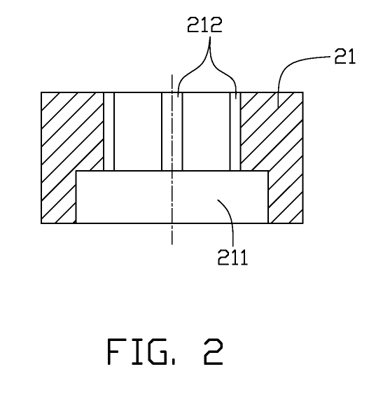

Referring also to FIG. 2, the base 21 defines a through hole 211 at a central portion of the base 21 and at least one slot 212. In the illustrated embodiment, there are four parallel slots 212 uniformly arranged in the through hole 211 and each of the slots 212 has a rectangular cross-section. In other embodiment, the cross-section of the slots 212 may be U-shaped, V-shaped, or arc-shaped. The through hole 211 has a stepped-shaped axis section and is configured for receiving the ejector sleeve 22 and the retainer 24.

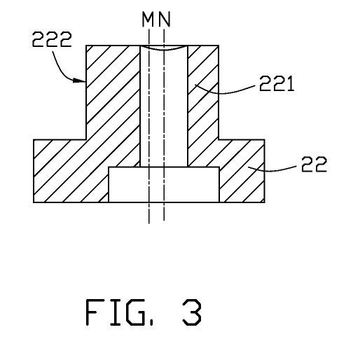

Referring also to FIG. 3, the ejector sleeve 22 defines a cavity hole 221 and a peripheral section 222 selectively facing the slots 212 of the base 21. The cavity hole 221 has a stepped-shaped axis section and is configured for receiving the cavity insert 23. An axis N of the cavity hole 221 is spaced from an axis M of the through hole 211 by a distance of approximately 0.005μ to 0.01μ. The ejector sleeve 22 has a stepped-shaped axial section corresponding to the shape and size of the through hole 211.

The cavity insert 23 includes a second molding surface 231 facing the first molding surface 110. The first and second molding surfaces 110, 231 define a space named as a mold cavity (not labeled) when the male and female mold portions 11, 12 are mated. In the illustrated embodiment, the mold cavity is used for molding a lens. The cavity insert 23 has a stepped-shaped configuration corresponding to the shape and size of the cavity hole 221.

The retainer 24 is configured for being inserted between one of the slots 212 and the peripheral section 222 to removably fix the ejector sleeve 22 to the base 21. In the illustrated embodiment, the retainer 24 is rectangular shaped. In other embodiment, the retainer 24 may be, for example, U-shaped, V-shaped, or arc-shaped to correspond to the shape and size of the slots 212. A size of the retainer 24 should be slightly smaller that a size of the slot 212 for facilitating repeated insertions of the retainer 24 into the slot 212. When the retainer 24 is taken out of the corresponding slot 212, the ejector sleeve 22 can be rotated in the through hole 211 to change a position of the second molding surface 231 relative to the first molding surface 110.

After a lens is molded, centers on opposite sides of the lens will be tested. If the centers of the lens are not in alignment, the retainer 24 is taken out of the corresponding slot 212 and the ejector sleeve 22 is rotated in the base 21 until the retainer 24 is inserted into another slot 212. The above steps are repeated until the second molding surface 231 aligns with the first molding surface 110.

It may be appreciated that the injection molding device 10 may include an even number of ejector sleeves 22 for receiving an even number cavity inserts 23. The even number of ejector sleeves 22 could be symmetrically arranged to decrease an imbalance of pressure generated molten plastic.

It should be understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. An injection molding device for thermosetting molding materials, comprising:
a male mold portion comprising a first molding surface defined therein; and
a female mold portion mating with the male mold portion, the female mold portion comprising:
a base defining a through hole;
an ejector sleeve received in the through hole and defining a cavity hole,
wherein an axis of the cavity hole is spaced from that of the through hole; and
a cavity insert received in the cavity hole, wherein the cavity insert comprises a second molding surface facing towards the first molding surface.

2. The injection molding device of claim 1, further comprising a retainer, wherein the female mold portion further comprises at least one slot for receiving the retainer, wherein an extending direction of the at least one slot is parallel to the axis of the through hole, wherein a dimension of the retainer is greater than that of the slot.

3. The injection molding device of claim 2, wherein the ejector sleeve defines a section for forming a space in cooperation with the slot to receive the retainer.

4. The injection molding device of claim 2, wherein the at least one slot comprises four slots.

5. The injection molding device of claim 2, wherein the slot has a U-shaped cross-section.

6. The injection molding device of claim 2, wherein the slot has a V-shaped cross-section.

7. The injection molding device of claim 2, wherein the slot has a rectangle cross-section.

8. The injection molding device of claim 2, wherein the slot has an arc-shaped cross-section.

9. The injection molding device of claim 1, wherein the ejector sleeve has a stepped-shaped axial section.

10. The injection molding device of claim 1, wherein a dimension of the retainer is less than that of the slot.

11. The injection molding device of claim 1, wherein the cavity insert has a stepped-shaped axial section.

12. The injection molding device of claim 1, wherein a distance between the axis of the through hole and that of the cavity hole is 0.005μ to 0.01μ.

13. The injection molding device of claim 1, wherein the male mold portion and female mold portion are made of metal.

14. The injection molding device of claim 1, wherein the first molding surface is configured for molding a subject which has a spherical surface.

15. The injection molding device of claim 1, wherein the first molding surface is configured for molding a subject which has an aspheric surface.
